(19) United States
(12) Patent Application Publication
(10) Pub. No.: US 2026/0098779 A1
(43) Pub. Date: Apr. 9, 2026

(54) LIQUID LEAKAGE DETECTION DEVICE AND LIQUID LEAKAGE DETECTION METHOD

(71) Applicant: SHENZHEN ENVICOOL TECHNOLOGY CO., LTD., Shenzhen City (CN)

(72) Inventors: CHENGSHENG SONG, Shenzhen City (CN); XIANWEN REN, Shenzhen City (CN)

(73) Assignee: SHENZHEN ENVICOOL TECHNOLOGY CO., LTD., Shenzhen City (CN)

(21) Appl. No.: 19/415,748

(22) Filed: Dec. 10, 2025

Related U.S. Application Data
(63) Continuation of application No. PCT/CN2024/136611, filed on Dec. 4, 2024.

(30) Foreign Application Priority Data
Dec. 29, 2023 (CN) 202311868315.3

(51) Int. Cl. G01M 3/18

(52) U.S. Cl. CPC G01M 3/182

(57) ABSTRACT

A liquid leakage detection device includes an isolation layer configured to warp around a pipe. A thin-film detection circuit is disposed on the isolation layer. The thin-film detection circuit includes at least one detection electrode loop. The isolation layer defines openings at positions corresponding to the at least one detection electrode loop. Whether a leakage occurs can be determined by obtaining a change in the resistance value of the detection electrode loop. Multiple liquid leakage detection devices can be connected in series and wrapped around a plurality of segments of a single pipe, or multiple liquid leakage detection devices can be connected in series and wrapped around multiple independent pipes one by one, thereby realizing liquid leakage detection of multiple pipe segments and directly locating the location of the leaky pipe in the event of a liquid leakage in the pipe, reducing the time and cost of liquid leakage detection.

### CROSS-REFERENCE

The present disclosure is a continuation application of PCT application No. PCT/CN2024/136611 filed on Dec. 4, 2024, which claims priority to a Chinese Patent Application No. 202311868315.3, filed on Dec. 29, 2023, titled “Leakage Detection Device and Leakage Detection Method”, the entire contents of which are incorporated herein by reference.

### FIELD

The present invention relates to the technical field of leakage detection, and in particular relates to a leakage detection device and a leakage detection method.

### BACKGROUND

At present, leakage detection solutions for pipes with a small outer diameter and complex structure, which are used in complex working conditions, is still immature, not only because of the complexity and variety of materials and structures of the pipes, but also because of the various types of liquids flowing in the pipes, which has brought great difficulties and challenges in the development of its detection performance and reliability.

The mainstream methods of detecting liquid leakage are to collect the liquid leakage by using a water collection tray, and then determine whether there is liquid leakage by detecting whether there is liquid in the water collection tray. For example, the following patents describe various methods for detecting liquid leakage.

China Patent Publication No. CN105988138A, titled “Weak Acidic Solution Leakage Sensing Device”, and China Patent Publication No. CN202613059U, entitled “A Liquid Leakage Detection Rope with Sheath”, disclose that a liquid leakage detection Rope or detection belt is mainly used for the detection in a large plane space, such as the ground, the bottom of the equipment and the line along the underground pipeline, and the principle is that the leaked liquid contacts a water detection sensing rope, resulting in a change of impedance or capacitance of the sensing rope.

The Japanese patent publication No. JP5782082B2”, titled “Leak Detector Using a Fibre Optic Funnel”, discloses a method of detecting liquid leaks using optical signals, in which a light incident on the surface of the fibre causes refraction of the optical signal at the leakage area, and the leakage detection is achieved by detecting a change in the signal at the receiving end.

The Japanese patent publication No. JP2007163255A, entitled “Leakage Detection Method, Leakage Detection System, and RFID Tag”, discloses a leakage detection method using RFID technology, and the principle is to make use of the fact that the capacitance of the detected liquid is significantly higher than that of air, and UHF signal transmission will be affected by the contact with the liquid.

In the case of multiple pipes connected in series, especially in the case of liquid-cooled data centres and other scenarios that require the effective operation of pipes over a long period of time, it is necessary to locate the position of the leak as quickly as possible when a pipe leakage occurs in order to solve the problem at the fastest possible speed. However, in the existing solutions for detecting leaks as described above, it is only possible to determine whether or not a leakage occurs, and it is not possible to locate and detect a leakage location or area at the present stage at a low cost. The location of the leak needs to be confirmed manually on-site, which is time-consuming and leads to a high cost of the leak detection.

### SUMMARY

The present application provides a leakage detection device and a detection method for solving the technical problem that pipe leakage cannot be located in a timely manner, resulting in costly and time-consuming pipe leakage detection.

According to one aspect of the present application, a liquid leakage detection device includes an isolation layer configured to warp around a pipe to be detected; and a thin-film detection circuit disposed on an outer wall of the isolation layer, the thin-film detection circuit comprising at least one detection electrode loop. The isolation layer defines a plurality of openings at positions corresponding to the at least one detection electrode loop.

In some embodiments, there are a plurality of such liquid leakage detection devices, the plurality of the liquid leakage detection devices being connected to each other by means of one or more thin-film electrode connectors to form a cascaded liquid leakage detection device;
in the cascaded liquid leakage detection device, the detection electrode loops of a plurality of the thin-film detection circuits are connected in series through the thin-film electrode connector to form a detection loop.

In some embodiments, the plurality of the liquid leakage detection devices is wrapped around a plurality of different pipe segments;
the detection loops to which the openings of the liquid leakage detection device correspond are different on different pipe segments.

In some embodiments, the thin-film detection circuit on each pipe segment comprises at least two such detection electrode loops.

In some embodiments, multiple such liquid leakage detection devices are configured to wrap around a plurality of different pipe segments respectively;
wherein each of the pipe segments corresponds to one detection loop.

In some embodiments, multiple such liquid leakage detection devices are configured to wrap around a plurality of different pipe segments respectively; wherein the number of the detection loops associated with m pipes is a, m≤(2a−1), where both a and m are positive integers.

In some embodiments, the thin-film electrode connector is a flip-type thin-film electrode connector or a drawer-type thin-film electrode connector; and/or

the thin-film electrode connector is a thin-film electrode connector with a pitch of 0.5 mm or 1.25 mm or 2.54 mm, and the number of pins of the thin-film electrode connectors is four times the number of the detection electrode loops connected to the thin-film electrode connectors.

In some embodiments, the liquid leakage detection device further includes a housing and a base layer, the base layer being disposed on an inner side of the housing, and the thin-film detection circuit being mounted on the base layer.

In another aspect, a method for detecting a liquid leakage is provided which is applied to a liquid-cooling pipe. The liquid-cooling pipe includes a pipe and a liquid leakage detection device as described above, the liquid leakage detection device wrapped around the pipe. The method includes the following steps:
periodically obtaining a change in the resistance value of the detection electrode loop of the liquid leakage detection device; and
determining that the pipe on which the liquid leakage detection device is located is leaking when the amount of change in the resistance value of the detection electrode loop exceeds a preset threshold.

In still another aspect, a method for detecting a liquid leakage is provided which is applied to a liquid-cooling pipe, wherein the liquid-cooling pipe comprises a plurality of pipe segments and a cascaded liquid leakage detection device formed by connecting a plurality of the liquid leakage detection devices as described above. The method includes:
periodically obtaining a resistance value between each set of pins of the thin-film electrode connectors on all detection loops respectively connected to the liquid leakage detection device;
when the amount of change of the resistance value between a set of pins exceeding a preset threshold compared to the resistance value of a previous period, acquiring a target detection loop to which said set of pins correspond;
determining the location of a leaky pipe segment based on a pin combination relationship of the target detection loop.

The liquid leakage detection device provided in the above embodiments has at least the following beneficial effects:

The liquid leakage detection device is used to be wrapped on a corresponding pipe. With the setting of the openings and detection electrode loops, when a liquid leakage occurs in the pipe, the liquid leakage liquid will change the resistance value of the detection electrode loop when it contacts the detection electrode loop through the opening, so that it can be determined whether a liquid leakage occurs by obtaining the change in the resistance value of the detection electrode loop. In this way, the leakage detection device, as an independent, standardized leakage detection component, can be separately wrapped around different pipes, the change in the resistance value of the detection electrode loops in different leakage detection devices is used to indicate whether or not there is a leakage in different pipes, thereby realizing leakage detection and location of different pipes. The leakage detection device has a simple structure and can be combined flexibly in use, which facilitates the timely positioning of the leakage location of multiple pipes, reduces the time for leakage detection and lowers the cost.

The liquid leakage detection method provided in the above embodiment belongs to the same concept as the corresponding embodiment of the liquid leakage detection device, and thus has at least the same technical effect as the corresponding embodiment of the liquid leakage detection device, and will not be repeated herein.

In addition to the objects, features and advantages described above, there are other objects, features and advantages of the present application. The present application will be described in further detail below with reference to the accompanying drawings.

### BRIEF DESCRIPTION OF THE DRAWINGS

The accompanying drawings, which form part of this application, are used to provide a further understanding of the present invention, and the schematic embodiments of the invention and their description are used to explain the invention and do not constitute an undue limitation of the invention. In the accompanying drawings:

FIG. 1 is a schematic structural diagram of a liquid leakage detection device according to an embodiment of the present disclosure.

FIG. 2 is a sectional view of the liquid leakage detection device shown in FIG. 1.

FIG. 3 is a schematic structural diagram of a cascaded liquid leakage detection device according to an embodiment of the present disclosure.

FIG. 4 is a schematic structural diagram of a cascaded liquid leakage detection device according to an alternative embodiment of the present disclosure.

FIG. 5 is a schematic structural diagram of a cascaded liquid leakage detection device according to another alternative embodiment of the present disclosure.

FIG. 6 is a flowchart of a liquid leakage detection method according to an embodiment of the present disclosure.

FIG. 7 is a flowchart of a liquid leakage detection method according to an alternative embodiment of the present disclosure.

FIG. 8 is a block diagram of a circuit for the liquid leakage detection according to one embodiment of the present disclosure.

### REFERENCE NUMERALS

1, Liquid leakage detection device; 1-1, First liquid leakage detection device; 1-2, Second liquid leakage detection device; 1-3, Third liquid leakage detection device; 10, Thin-film detection circuit; 11, Detection electrode loop; 111, Detection electrode; 12, Opening; 13, Isolation layer; 14, Thin-film detection circuit; 15, Housing; 16, Base layer; 2, Thin-film electrode connector; 3, Detection loop; 3-1, First detection loop; 3-2, Second detection loop; 3-3, Third detection loop.

### DESCRIPTION OF THE EMBODIMENTS

Embodiments of the present invention are described in detail below in conjunction with the accompanying drawings, but the present invention may be practiced in a number of different ways as defined and covered by the claims.

In addition, unless otherwise defined, technical or scientific terms used in the description of the present application shall have the ordinary meaning as understood by a person of ordinary skill in the art to which the present application belongs. As used in the description of the present application, “top”, “bottom”, “left”, “right”, “center,” ‘vertical,’ ‘horizontal,’ ‘inside,’ ‘outside,’ and the like used in this application description to indicate orientation. Words such as “orientation” are only used to indicate relative directions or positional relationships, and do not imply that the device or component must have a specific orientation, be constructed and operated in a specific orientation, and when the absolute position of the described object is changed, its relative positional relationship may also be changed accordingly, and therefore cannot be construed as a limitation of the present application. The terms “first”, “second”, “third” and the like used in the description of the present application are used only for descriptive purposes to distinguish between different components, and cannot be construed as indicating or implying relative importance. The terms “one”, “a”, “the”, and the like, as used in the description of the present application, should not be construed as an absolute limitation on the number, but rather as the existence of at least one such item. Words such as “including” or “comprising” as used in the description of the present application are intended to mean that the component or object preceded by the word covers the components or objects listed after the word, and their equivalents, and does not exclude other components or objects.

It should also be noted that, unless otherwise expressly provided and limited, the words “mounted”, “connected”, “linked” and the like as used in the description of the present application are to be understood in a broad sense. For example, the connection may be a fixed connection, a removable connection, or a one-piece connection; it may be a mechanical connection or an electrical connection; it may be a direct connection, an indirect connection through an intermediate medium, or a connection within two elements, and the person skilled in the art may understand the specific meaning in the present application according to the specific circumstances.

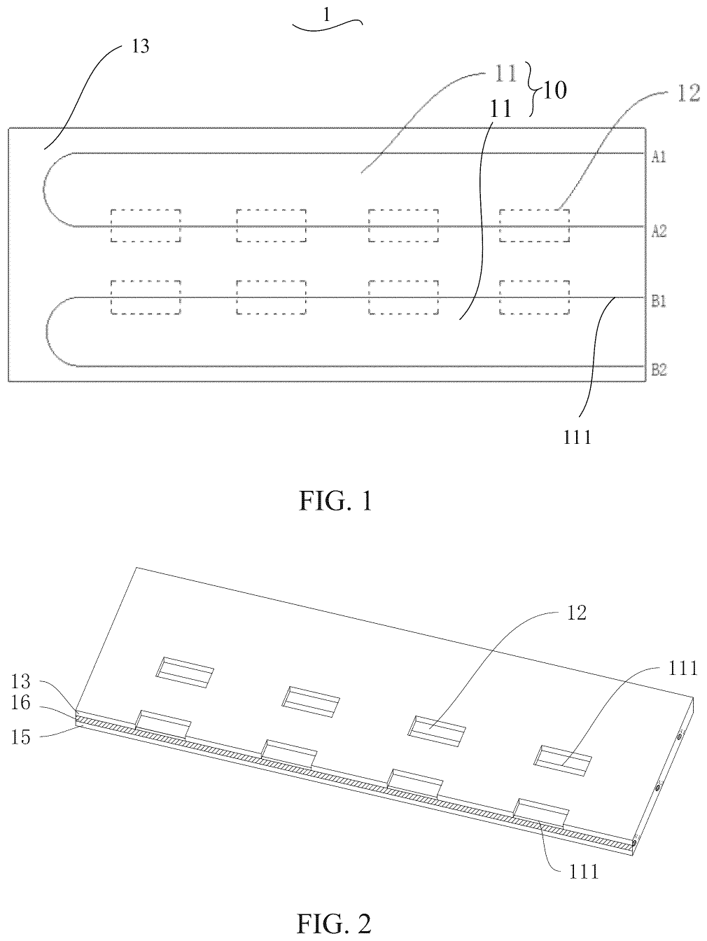

As shown in FIG. 1, a liquid leakage detection device 1 according to an embodiment of the present disclosure comprises an isolation layer 13 and a thin-film detection circuit 10 disposed on an outer wall of the isolation layer 13. The thin-film detection circuit 10 comprises at least one detection electrode loop 11. The isolation layer 13 defines a plurality of openings 12 at a position corresponding to the detection electrode loop 11. The isolation layer 13 is configured to wrap around a pipe to be detected.

Referring to FIG. 2, optionally, the leakage detection device 1 of the present embodiment further comprises a housing 15 and a base layer 16 being disposed on an inner side of the housing 15. The thin-film detection circuit 10 is mounted on the base layer 16. The housing 15 is an enclosing housing, and the base layer 16 is bonded on the inner side of the housing 15. It is to be noted that the bonding mode to connect the base layer 16 to the housing 15 in this embodiment is used for exemplary illustration only, and is not to be understood as a limitation of the present application, and in other embodiments, any other connecting methods may be used to connect the base layer 16 and the housing 15 together. The thin-film detecting circuit 10 is disposed on the inner side of the base layer 16, and the thin-film detecting circuit 10 comprises at least one detection electrode loop 11, the detection electrode loop 11 comprises detecting electrodes and a conductor for forming the circuit. The inner side of the detection electrode loop 11 is provided with an isolation layer 13, the isolation layer 13 defines a through opening 12 at a position corresponding to each of the detection electrodes, so that when the pipe leaks, the leakage liquid can flow into the thin-film detection circuit 10 through the openings 12. When the liquid leakage detection device is wrapped around the pipe, the isolation layer 13 can prevent the detection electrode loop 11 from contacting the pipe in an area other than the opening 12. When the pipe leaks, the liquid will flow into the thin-film detection circuit 10 only through the opening 12, and the liquid will only affect the region of the detection electrode loop 11 corresponding to the opening 12 of the isolation layer 13, and the detection electrode loop 11 outside the region corresponding to the opening 12 will not be affected by the liquid.

Specifically, as shown in FIG. 1, in this embodiment, the thin-film detection circuit 10 includes two detection electrode loops 11, each of which defines four openings 12. In other embodiments, the thin-film detection circuit 10 may comprise any number of detection electrode loops 11, such as one, three, four, or more, and each of the detection electrode loops 11 may define one, two, three, five or more openings 12.

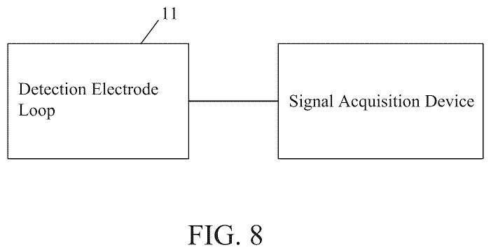

Referring also to FIG. 8, in this embodiment, ends of all of the detection electrode loops 11 are connected to a signal acquisition device, and the number of pins on the signal acquisition device is twice the number of the detection electrode loops 11. Each of the detection electrode loops 11 is provided with two lines of input and output, as shown in FIG. 1, with the terminal A1 indicating the input end of one of the detection electrode loops 11, and the terminal A2 indicating the output end of the detection electrode loop 11. The number of the pins on the signal acquisition device usually corresponds one-to-one with the input and output ends of the detection electrode loop 11. As shown in FIG. 1, the dashed box indicates the opening 12, and when two detection electrode loops 11 are applied, the signal acquisition device connects to the inputs and outputs, A1, A2, B1, and B2, of the two detection electrode loops 11 respectively, and the terminals of different detection electrode loops 11 are made to be connected periodically, for example, connecting terminals A1A2, A1B1, A1B2, A2B1, A2B2, and B1B2 in sequence. Thus, the signal acquisition device may periodically acquire signals from the terminals A1A2, A1B1, A1B2, A2B1, A2B2, B1B2. The signals may be signals of current, voltage, or resistance, or the like. Specifically, the signal acquisition device in this embodiment acquires a resistance value between the two terminals.

In the liquid leakage detection device 1 of this embodiment, when the pipe leaks liquid which flows into the opening 12 and comes into contact with the detection electrode loop 11, the liquid will make the two detection electrode loops 11 conductive, which results in the resistance values acquired by the terminals A1B1, A1B2, A2B1 and A2B2 generating obvious changes. Thus, it can be judged whether or not a liquid leakage occurs by acquiring the change of the resistance value of the detection electrode loops 11. The liquid leakage detection device 1 can be used to recognize the leakage information of the corresponding pipe as an independent and standard liquid leakage detection component. Multiple liquid leakage detection devices 1 can be individually and separately wrapped around different pipes. By utilizing the resistance changes produced by the detection electrode loops 11 in different leak detection devices 1, whether there is a liquid leakage in the different pipes can be correspondingly indicated, which enables liquid leakage detection and location for different pipes. The liquid leakage detection device 1 has a simple structure and its combination ways are flexible, which facilitates timely location of leakage positions in multiple pipes, reducing the time and cost of liquid leakage detection.

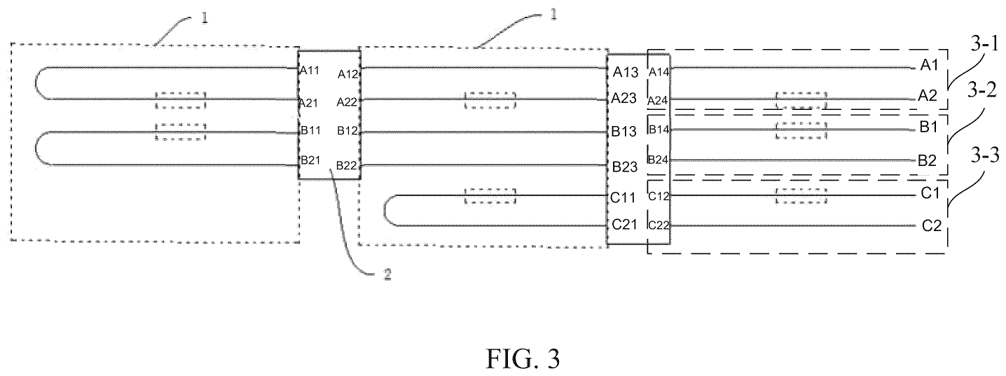

As shown in FIG. 3, in some embodiments, a plurality of liquid leakage detection devices 1 may be applied. The plurality of liquid leakage detection devices 1 are connected to each other by thin-film electrode connectors 2 to form a cascade liquid leakage detection device, and the detection electrode loops 11 of the plurality of liquid leakage detection devices 1 are connected to each other in cascade to form a cascade thin-film electrode. In the cascade type thin-film electrode, the plurality of detection electrode loops 11 of the liquid leakage detection device 1 are connected in series via the thin-film electrode connectors 2 to form a detection loop 3.

When being applied for a liquid-cooling pipe comprising multiple pipe segments which are connected with various forms of connectors, a plurality of liquid leakage detection devices 1 may be wrapped around the outside of the multiple pipe segments. The liquid leakage detection devices 1 match the pipe in shape and size. In order to better match the liquid-cooling pipe comprising a plurality of pipe segments, the leakage detection devices 1 wrapped around the pipe segments are further connected in series by the thin-film electrode connectors 2. The thin-film electrode connectors 2 may correspond to the joints between adjacent pipe segments, and the terminals at opposite sides of the thin-film electrode connectors 2 are connected to two detection electrode loops 11 respectively. Thus, the detection electrode loops 11 of all the liquid leakage detection devices 1 may be connected in series by the thin-film electrode connectors 2 to form a cascaded thin-film electrode detection loop 3. The changes of the resistance values detected by the detection electrode loops 11 of the leakage detection devices 1 at different locations correspond to the changes of the resistance values in the detection loops 3 containing the corresponding detection electrode loops 11, so that the changes in the resistance values detected by the different detection loops 3 correspond to the locations of the leakage of the different pipe segments, respectively. Optionally, in the cascaded thin-film electrode, the number of the detection loops 3 may be the same as the number of detection electrode loops 11 included in the liquid leakage detection device 1 having the maximum number of detection electrode loops 11. Alternatively, the detection electrode loops 11 corresponding to some pipe segments may be selected to connect in series in order to form the detection loops 3, i.e. the number of the detection loops 3 may be less than the number of the detection electrode loops 11 contained in the liquid leakage detection device 1 having a maximum number of detection electrode loops 11.

In this embodiment, the thin-film electrode connector 2 is a flip-type thin-film electrode connector or a drawer-type thin-film electrode connector. The thin-film electrode connector 2 is a thin-film electrode connector with a pitch of 0.5 mm or 1.25 mm or 2.54 mm, and the number of pins of the thin-film electrode connector 2 is four times the number of the detection electrode loops 11 connected to the thin-film electrode connector 2. For example, when the thin-film electrode connector 2 is connected to two detection loops 3, since each detection loop 3 is equipped with two wires, i.e., one input wire and one output wire, and each wire needs to pass through the thin-film electrode connector 2, each detection loop 3 formed by the plurality of detection electrode loops 11 connected in series needs to occupy four pins of the thin-film electrode connector 2.

In this embodiment, the plurality of liquid leakage detection devices 1 are wrapped around a plurality of different pipe segments. On different pipe segments, the detection loops 3, to which the openings 12 of the isolation layer 13 of the liquid leakage detection devices 1 correspond, are different.

Depending on the number of the pipe segments, it is necessary to use the liquid leakage detection devices 1 having a different number of detection electrode loops 11 to wrap all of the pipe segments, thereby forming a different number of detection loops 3. As shown in FIG. 3, the present embodiment is exemplarily illustrated as having three pipe segments and three detection circuits 3, wherein A1A2 denotes the first detection loop 3-1, B1B2 denotes the second detection loop 3-2, C1C2 denotes the third detection circuit 3-3, and a first pipe segment, a second pipe segment, and a third pipe segment are arranged from left to right and correspond to a first liquid leakage detection device 1-1, a second liquid leakage detection device 1-2, and a third liquid leakage detection device 1-3, respectively. The first detection loop 3-1 and the second detection loop 3-2 both are wrapped on all of the pipe segments, and the third detection loop 3-3 is wrapped on the second pipe segment and the third pipe segment. On the first pipe segment, the openings 12 of the isolation layer 13 of the first liquid leakage detection device 1-1 are located at positions corresponding to the first detection loop 3-1 and the second detection loop 3-2. On the second pipe segment, the openings 12 of the isolation layer 13 of the second liquid leakage detection device 1-2 are located at positions corresponding to the first detection loop 3-1 and the third detection loop 3-3. On the third pipe segment, the openings 12 of the isolation layer 13 of the third liquid leakage detection device 1-3 are located at positions corresponding to the first detection loop 3-1, the second detection loop 3-2 and the third detection loop 3-3.

It is to be noted that illustrating the present embodiment with three pipe segments as an example cannot be construed as a limitation of the present application. In other embodiments, four, five or even more pipe segments may be detected. For each additional pipe segment, an additional detection loop 3 may be added accordingly. Whether the additional pipe segment has a liquid leakage or not can be determined through the newly added detection loop 3. If the newly added detection circuit 3 detects a liquid leakage, it can be determined that the additional pipe segment has a liquid leakage.

In the cascaded thin-film electrode, the detection circuits 3 to which the openings 12 of the isolation layer 13 of the different liquid leakage detection devices 1 correspond are different. For example, the openings 12 of the isolation layer 13 of the first liquid leakage detection device 1-1 correspond to the first detection circuit 3-1 and the second detection circuit 3-2, and the openings 12 of the isolation layer 13 of the liquid leakage detection device 1 on the other pipe segments cannot correspond to the first detection circuit 3-1 and the second detection circuit 3-2 at the same time. When a pipe segment leaks, the leaked liquid will cover the openings 12 of the isolation layer 13 of the liquid leakage detection device 1 on the leaky pipe segment, and the resistance value of the detection loop 3 in contact with the liquid will change. By detecting the change of the resistance values collected by all of the detection loops 3, the specific location of the leaky pipe segment can be determined, thereby timely identifying the leakage positions in multiple pipes, reducing the time and cost of liquid leakage detection.

The signal acquisition device periodically connects the two terminals of the detection loops 3 to collect data between the two terminals. In this embodiment, a total of six terminals A1, A2, B1, B2, C1, and C2 of the three detection loops 3 are connected to the signal acquisition device and generate a total of 15

$$( i . e . {C}_{6}^{2} )$$

possibilities. For example, when the first pipe leaks liquid, at this time, the liquid flows into the openings 12 of the isolation layer 13 of the first leakage detection device 1-1 on the first pipe, causing the first detection loop 3-1 and the second detection loop 3-2 to conduct, such that the resistance value between the terminals A2B1 collected by the signal acquisition device is changed, while the resistance value between the terminals A2C1 does not change; when the second pipe leaks liquid, the liquid flows into the openings 12 of the isolation layer 13 of the second leakage detection device 1-2 on the second pipe, causing the first detection circuit 3-1 and the third detection circuit 3-3 to conduct, such that the resistance value between the terminals A2C1 collected by the signal acquisition device is changed, while the resistance value between the terminals A2B1 does not change; when the third pipe leaks liquid, the liquid flows into the openings 12 of the isolation layer 13 of the third leakage detection device 1-3 on the third pipe, causing the first detection circuit 3-1, second detection circuit 3-2, and the third detection circuit 3-3 to all conduct through the liquid, such that the resistance values between the terminals A2B1 and the terminals A2C1 collected by the signal acquisition device are both changed.

In this embodiment, the liquid leakage detection device 1 on each pipe includes at least two detection electrode loops 11, so that when one detection loop 11 fails, the detection can be performed by the other detection loop 11, which greatly enhances the reliability of the detection device 1.

Working principle of the present embodiment: since the liquid leakage detection device 1 is provided with the internal detection electrode loops 11, and each of the detection electrode loops 11 is provided with a detection electrode 111 at an opening 12 of the isolation layer 13, when the liquid leaked from the pipe contacts the detection electrode 111, it will cause a change in the resistance value of the detection loop 3 to which the detection electrode loops 11 corresponds. Based on this principle, for example, when the resistance value between the terminals A2B1 collected by the signal acquisition device changes, while the resistance value between the terminals A2C1 does not change, it is determined that the first pipe is leaking liquid; when the resistance value between terminals A2C1 collected by the signal acquisition device changes, while the resistance value between terminals A2B1 does not change, it is determined that the second pipe is leaking liquid; when both the resistance values between terminals A2B1 and A2C1 collected by the signal acquisition device change, it is determined that the third pipe is leaking liquid.

The liquid leakage detection device of the present embodiment can quickly and accurately locate the position of the leaky pipe, greatly reducing the time for the liquid leakage detection and location and reducing the detection cost.

In some embodiments, in the cascaded thin-film electrodes, each pipe segment corresponds to one detection loop 3.

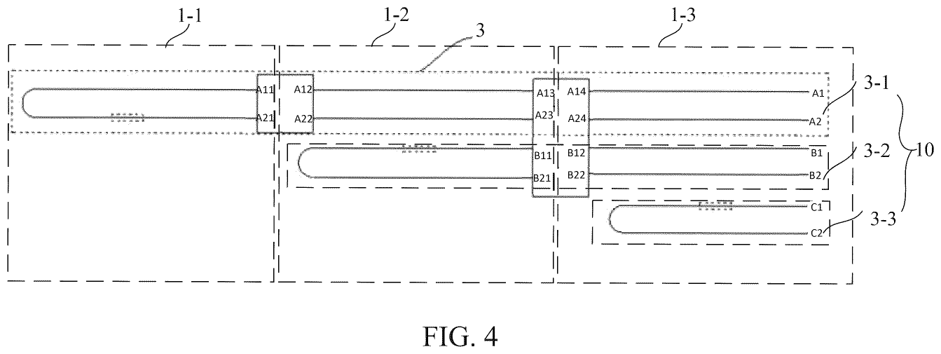

Referring to FIG. 4, three pipe segments and three detection electrode loops are illustrated as an example, wherein A1A2 denotes a first detection loop 3-1, B1B2 denotes a second detection loop 3-2, and C1C2 denotes a third detection loop 3-3, which are divided by the thin-film electrode connectors 3. A first pipe segment, a second pipe segment, and a third pipe segment are arranged in sequence from left to right, with the first detection loop 3-1 wrapping all of the pipe segments, the second detection loop 3-2 wrapping the second pipe segment and the third pipe segment, and the third detection loop 3-3 wrapping only the third pipe segment.

The number of the detection loops 3 in this embodiment is the same as the number of pipe segments, and each detection loop 3 needs the opening to be defined corresponding to only one pipe segment. Therefore, the signal acquisition device only needs to obtain the change in the resistance value of each detection loop 3, and does not need to obtain the data of each two connected terminals by periodic refreshing. For example, when the resistance value of A1A2 is changed, it indicates that the first pipe segment leaks liquid; when the resistance value of B1B2 is changed, it indicates that the second pipe segment leaks liquid; and when the resistance value of C1C2 is changed, it indicates that the third pipe segment leaks. This can further reduce the time, difficulty and complexity of data acquisition.

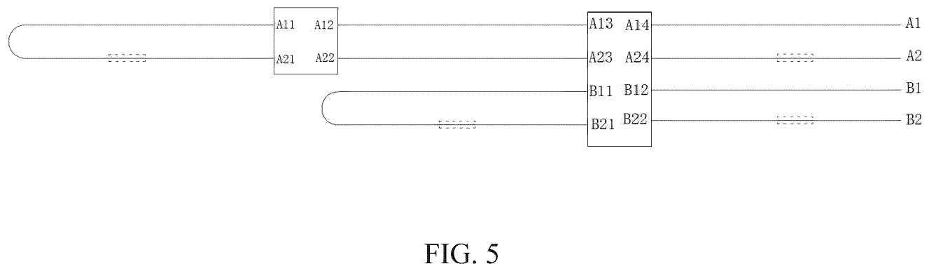

In some embodiments, referring to FIG. 5, the number of detection loops 3 required for m pipe segments is n, m≤(2ⁿ−1), wherein both a and m are positive integers.

Since each detection loop 3 has two cases of “with opening” and “without opening” on each pipe segment, n detection loops 3 can generate (2ⁿ−1) possible combinations, and each combination can be assigned to each pipe segment respectively, so that n detection loops 3 can be used for detection of a maximum of (2ⁿ−1) pipe segments. For example, leakage detection of seven pipe segments can be realized with only three detection loops 3, respectively indicated by A, B, C, then there will be a total of the following seven results: A, B, AB, C, AC, BC, ABC, these seven loop combinations require the openings respectively formed in the detection devices on the seven pipe segments, and the signal acquisition device collects the resistance values corresponding to the seven combinations. Any corresponding pipe segment can be determined to leak when the corresponding resistance value changes. Therefore, the required number of the detection loops 3 can be known based on the number of the pipe segments. The number of the detection loops 3 is related to the number of the detection electrode loops 11 of the leakage detection devices 1 and, therefore, the leakage detection devices 1 with the lowest total number of detection electrode loops 11 can be selected to realize the loop combinations to reduce the structural complexity and the structure cost, and at the same time reduce the area occupied by the detection electrode loops 11.

In this embodiment, taking three pipe segments as an example for illustration, two detection loops 3 can realize the detection of the three pipe segments, wherein A1A2 denotes the first detection electrode loop 3-1, B1B2 denotes the second detection electrode loop 3-2, which are divided by the thin-film electrode connector 2. A first pipe segment, a second pipe segment, and a third pipe segment are arranged from left to right. The first detection loop 3-1 wraps around the first pipe segment and the second pipe segment, and the second detection loop 3-2 wraps around the second pipe segment and the third pipe segment. On the first pipe segment, the opening 12 of the isolation layer 13 of the liquid leakage detection device 1 is opened at a position corresponding to the first detection loop. On the second pipe segment, the opening 12 of the isolation layer 13 of the liquid leakage detection device 1 is opened at a position corresponding to the second detection loop 3-2. On the third pipe segment, the opening 12 of the isolation layer 13 of the liquid leakage detection device 1 is opened at a position corresponding to the first detection loop 3-1 and the second detection loop 3-2.

When the signal acquisition device collects a change in the resistance value of A1A2 and no change of B1B2, then it indicates a leakage in the first pipe segment; when the signal acquisition device collects a change in the resistance value of B1B2 and no change of A1A2, then it indicates a leakage in the second pipe; and when the signal acquisition device collects a change in the resistance value of both A1A2 and B1B2, then it indicates a leakage in the third pipe. In embodiments with more pipe segments, the leakage detection can be performed based on the same principle as in the present embodiment.

Compared to Embodiment 1 and Embodiment 2, the present embodiment can realize the precise location of the leaky pipe with a minimum number of detection electrode loops 1, which greatly reduces the structural complexity of the thin-film detection circuit 10, and reduces the consumption of materials and cost.

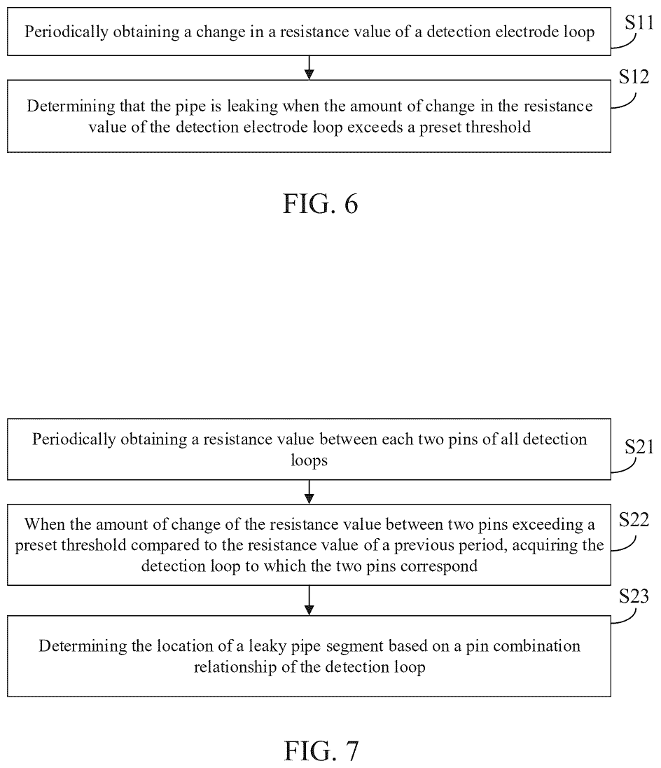

Referring to FIG. 6, another aspect of the present application provides a method of detecting a liquid leakage applied to a liquid-cooling pipe, the liquid-cooling pipe comprising a pipe and a liquid leakage detection device 1 wrapped around the pipe, the method comprising the following steps:
S11, periodically obtaining a change in a resistance value of a detection electrode loop.
S12, determining that the pipe is leaking when the amount of change in the resistance value of the detection electrode loop exceeds a preset threshold.

By implementing the liquid leakage detection method of the present embodiment, it is possible to timely and accurately determine whether the pipe is leaking.

Referring to FIG. 7, another aspect of the present application provides another liquid leakage detection method applied to a liquid-cooling pipe, the liquid-cooling pipe including a plurality of pipe segments and a cascade-type thin-film electrode as in the embodiment shown in FIG. 3 or FIG. 4, the method comprising:
S21, periodically obtaining a resistance value between each two pins on all detection loops.

Wherein, each detection electrode loop 11 has two pins, and N detection loops have a total of 2N pins, and the signal acquisition device periodically acquires

$${C}_{2 N}^{2}$$

sets of data so that all resistance value data between each two pins can be acquired.
S22, when the amount of change in the resistance value between two pins compared to the resistance value of a previous period exceeds a preset threshold, acquiring the detection loop to which the two pins correspond.
S23, determining the location of a leaky pipe segment based on a pin combination relationship of the detection loop.

Taking the cascaded thin-film electrode in the embodiment shown in FIG. 3 as an example, the signal acquisition device periodically acquires resistance data between 15 sets of terminals, the 15 sets of terminals being A1A2, A1B1, A1B2, A1C1, A1C2, A2B1, A2B2, A2C1, A2C2, B1B2, B1C1, B1C2, B2C1, B2C2, and C1C2. When a leakage occurs in the first pipe segment to which the first leakage detection device 1-1 corresponds, the resistance values of A1A2, A1B1, A1B2, A2B1, A2B2, B1B2 all change, while the resistance values of A1C1, A1C2, A2C1, A2C2, B1C1, B1C2, B2C1, B2C2, C1C2 do not change; when a leakage occurs in the second pipe segment to which the second leakage detection device 1-2 corresponds, the resistance values of A1A2, A1C1, A1C2, A2C1, A2C2 and C1C2 change, while the resistance values of A1B1, A1B2, A2B1, A2B2, B1B2, B1C1, B1C2, B2C1 and B2C2 do not change; when a leakage occurs in the third pipe segment to which the third leakage detection device 1-3 corresponds, the resistance values of A1A2, A1B1, A1B2, A1C1, A1C2, A2B1, A2B2, A2C1, A2C2, B1B2, B1C1, B1C2, B2C1, B2C2, C1C2 all change. Based on the change in the resistance values of different terminals, it can be determined whether there is liquid entering the detection electrodes 111 of the detection loops 3, thereby determining the location of the leaky pipe.

By implementing the liquid leakage detection method of this embodiment, liquid leakage detection can be performed for multiple pipe segments, which can timely and accurately determine whether the pipe is leaking or not, and can also determine the specific location of the leaky pipe.

The foregoing are only preferred embodiments of the present invention, and are not intended to limit the present invention. Various changes and variations could be made by those skilled in the art. Any modification, equivalent replacement, improvement made within the spirits and principles of the present invention shall be included in the scope of protection of the present invention.

What is claimed is:

1. A liquid leakage detection device comprising:
an isolation layer configured to warp around a pipe to be detected; and
a thin-film detection circuit disposed on an outer wall of the isolation layer, the thin-film detection circuit comprising at least one detection electrode loop;
wherein the isolation layer defines a plurality of openings at positions corresponding to the at least one detection electrode loop.

2. The liquid leakage detection device according to claim 1, wherein there are a plurality of such liquid leakage detection devices, the plurality of the liquid leakage detection devices being connected to each other by means of one or more thin-film electrode connectors to form a cascaded liquid leakage detection device;
in the cascaded liquid leakage detection device, the detection electrode loops of a plurality of the thin-film detection circuits are connected in series through the thin-film electrode connector to form a detection loop.

3. The liquid leakage detection device according to claim 2, wherein the plurality of the liquid leakage detection devices is wrapped around a plurality of different pipe segments, respectively;
the detection loops to which the openings of the liquid leakage detection device correspond are different on different pipe segments.

4. The liquid leakage detection device according to claim 3, wherein the thin-film detection circuit on each pipe segment comprises at least two such detection electrode loops.

5. The liquid leakage detection device according to claim 2, wherein multiple such liquid leakage detection devices are configured to wrap around a plurality of different pipe segments respectively;
wherein each of the pipe segments corresponds to one detection loop.

6. The liquid leakage detection device according to claim 2, wherein multiple such liquid leakage detection devices are configured to wrap around a plurality of different pipe segments respectively; wherein the number of the detection loops associated with m pipe segments is n, m≤(2ⁿ−1), where both n and m are positive integers.

7. The liquid leakage detection device according to claim 2, wherein the thin-film electrode connector is one of a flip-type thin-film electrode connector or a drawer-type thin-film electrode connector; and/or
the thin-film electrode connector is a thin-film electrode connector with a pitch of 0.5 mm or 1.25 mm or 2.54 mm, and the number of pins of the thin-film electrode connectors is four times the number of the detection electrode loops connected to the thin-film electrode connectors.

8. The liquid leakage detection device according to claim 1, further comprising a housing and a base layer, the base layer being disposed on an inner side of the housing, and the thin-film detection circuit being mounted on the base layer.

9. A method for detecting a liquid leakage, applied to a liquid-cooling pipe, wherein the liquid-cooling pipe comprises a pipe and a liquid leakage detection device as claimed in claim 1, the liquid leakage detection device wrapped around the pipe, the method comprising the following steps:
periodically acquiring a change in a resistance value of the detection electrode loop of the liquid leakage detection device; and
determining that the pipe on which the liquid leakage detection device is located is leaking when the amount of change in the resistance value of the detection electrode loop exceeds a preset threshold.

10. A method for detecting a liquid leakage, applied to a liquid-cooling pipe, wherein the liquid-cooling pipe comprises a plurality of pipe segments and a cascaded liquid leakage detection device formed by connecting a plurality of the liquid leakage detection devices as claimed in claim 1, the method comprising:
periodically acquiring a resistance value between each set of pins of the thin-film electrode connectors on all detection loops respectively connected to the liquid leakage detection device;
when the amount of change of the resistance value between a set of pins exceeding a preset threshold compared to the resistance value of a previous period, identifying a target detection loop to which said set of pins correspond;
determining the location of a leaky pipe segment based on a pin combination relationship of the target detection loop.

11. The method according to claim 10, wherein each detection electrode loop has two pins, and periodically acquiring a resistance value comprises periodically acquiring C_{2N}² sets of data so that all resistance value data between each two pins is acquired, where N is the number of the detection loops.
